(19) United States
(12) Patent Application Publication
(10) Pub. No.: US 2021/0325195 A1
(43) Pub. Date: Oct. 21, 2021

(54) Systems and Methods for Automated Vehicle Routing Using Relaxed Dual Optimal Inequalities for Relaxed Columns

(71) Applicant: Insurance Services Office, Inc., Jersey City, NJ (US)

(72) Inventors: Naveed Haghani, Fulton, MD (US); Claudio Contardo, Montreal (PQ) (CA); Julian Yarkony, Jersey City, NJ (US)

(73) Assignee: Insurance Services Office, Inc., Jersey City, NJ (US)

(21) Appl. No.: 17/235,539

(22) Filed: Apr. 20, 2021

Related U.S. Application Data
(60) Provisional application No. 63/012,712, filed on Apr. 20, 2020.

(51) Int. Cl. G01C 21/34; B60W 60/00

(52) U.S. Cl. CPC G01C 21/3453; B60W 60/001

(57) ABSTRACT

Systems and methods for automated vehicle routing using column generation optimization are provided. The system receives capacitated vehicle routing problem (CVRP) input data and generates a minimum weight set cover problem formulation for a CVRP for performing column generation optimization over the input data. The system determines smooth-dual optimal inequalities (S-DOI) and flexible-dual optimal inequalities (F-DOI) for the CVRP for performing the column generation optimization over a valid subset of the input data. Then, the system adapts the S-DOI and the F-DOI to generate smooth and flexible dual optimal inequalities (SF-DOI) for the CVRP for performing the column generation optimization over a relaxed subset of the input data. The system utilizes the SF-DOI to accelerate column generation optimization over the relaxed subset of the input data.

### RELATED APPLICATIONS

This application claims priority to U.S. Provisional Patent Application Ser. No. 63/012,712 filed on Apr. 20, 2020, the entire disclosure of which is hereby expressly incorporated by reference

### BACKGROUND

### Technical Field

The present disclosure relates generally to the automated vehicle routing. More particularly, the present disclosure relates to systems and methods for vehicle routing using relaxed dual optimal inequalities for relaxed columns.

### RELATED ART

The capacitated vehicle routing problem (CVRP) concerns determining a set of routes on a road network for respective vehicles having a limited carrying capacity of goods that must be delivered from one or more depots to a set of customers. A solution to the CVRP optimizes the route of each vehicle, where each vehicle travels along a route that begins and ends at its respective depot, such that customer requirements and operational constraints are satisfied while minimizing cost (e.g., fuel and/or distance traveled). The CVRP is increasingly important for a variety of industries (e.g., electronic commerce) and applications thereof (e.g., supply chain management and shipping) where transportation can be a significant component of the cost of a product.

The CVRP can be formulated as a minimum weight set cover problem. Column generation (CG) is a known approach for solving a minimum weight set cover problem and CG can be accelerated by utilizing dual optimal inequalities which decrease a size of the space of dual solutions that CG searches over. The CVRP considers a super-set of columns including original columns (e.g., valid columns) and additional columns (e.g., relaxed columns) to increase tractability of pricing. Pricing refers to the process of identifying negative reduced cost columns and operates by solving a small scale combinatorial optimization problem parameterized by the dual solution of an expanded linear program (LP). In the CVRP, a column is valid if it (1) does not include a customer more than once (e.g., no cycles in the corresponding route), and (2) does not service more demand than the vehicle has capacity. The pricing problem for the CVRP is an elementary resource constrained shortest path problem, which is strongly non-deterministic polynomial-time hard (NP-hard). A super-set of the set of valid columns, referred to as ng-routes, can facilitate solving large CVRP instances. Utilizing ng-routes can provide for making pricing tractable at the cost of a decrease in the tightness of the underlying expanded LP relaxation. The ng-route relaxation provides for a customer to be visited more than once in a route but precludes many short cycles localized in space. However, smooth and flexible dual optimal inequalities (SF-DOI) do not provide for modeling ng-route relaxed columns.

Thus, what would be desirable is a system and method for automated vehicle routing that utilizes SF-DOI to automatically and efficiently accelerate CG optimization over ng-routes relaxed columns. Accordingly, the systems and methods disclosed herein solve these and other needs.

### SUMMARY

This present disclosure relates to systems and methods for automated vehicle routing using relaxed dual optimal inequalities for relaxed columns. In particular, the system determines valid smooth dual optimal inequalities (S-DOI) for a capacitated vehicle routing problem (CVRP) where optimization is performed over a set of valid columns. The system also determines valid flexible dual optimal inequalities (F-DOI) for the CVRP where optimization is performed over the set of valid columns. Then, the system adapts the S-DOI and the F-DOI to yield smooth and flexible dual optimal inequalities (SF-DOI) with respect to ng-route relaxed columns. The system utilizes the SF-DOI as relaxed DOI for the ng-route relaxed columns to accelerate column generation optimization over the ng-route relaxed columns.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating an embodiment of the system of the present disclosure;

FIG. 2 is a flowchart illustrating overall processing steps carried out by the system of the present disclosure;

FIG. 3 is a flowchart illustrating step 52 of FIG. 2 in greater detail;

FIG. 4 is a diagram illustrating step 54 of FIG. 2 in greater detail;

FIG. 5 is a diagram illustrating step 56 of FIG. 2 in greater detail;

FIG. 6 is a table illustrating processing results of the system of the present disclosure;

FIGS. 7A-B are graphs illustrating relative duality gaps; and

FIG. 8 is a diagram illustrating another embodiment of the system of the present disclosure.

### DETAILED DESCRIPTION

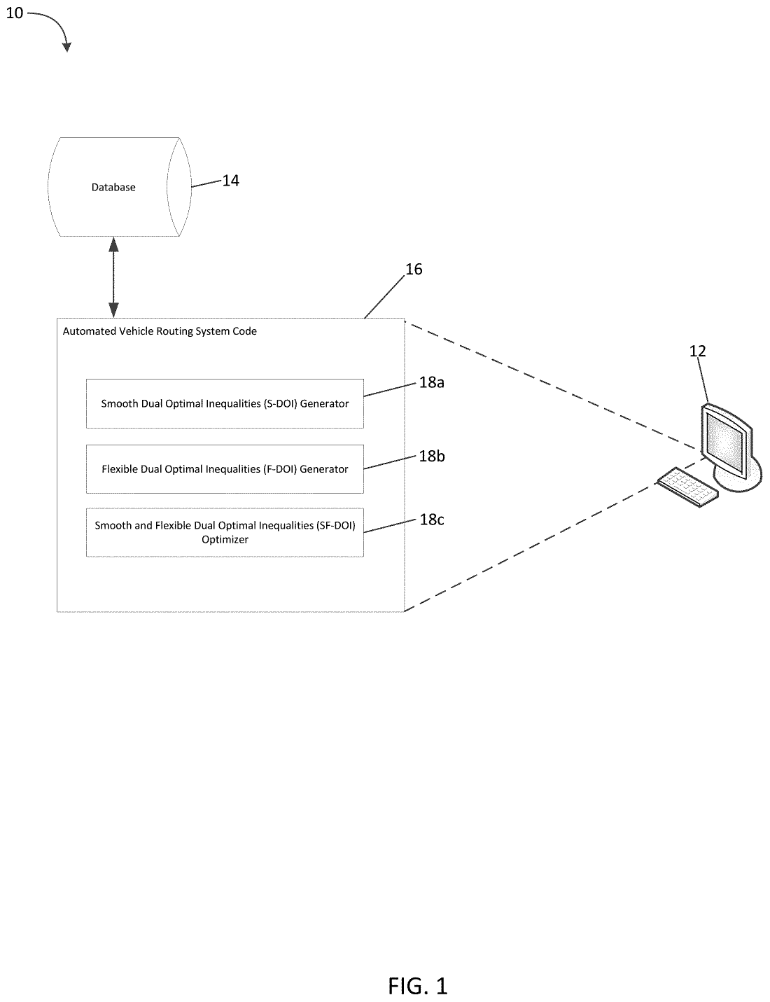

The present disclosure relates to systems and methods for automated vehicle routing using relaxed dual optimal inequalities for relaxed columns, as described in detail below in connection with FIGS. 1-8.

By way of background, the systems and methods of the present disclosure accelerate the CG solution to expanded LP relaxations utilizing DOI. Expanded LP relaxations are utilized to solve integer linear programs (ILPs) for which compact LP relaxations are loose. Compact LP relaxations contain a small number of variables whereas expanded LP relaxations contain a large number of variables (e.g., columns). An expanded LP relaxation is typically much tighter than a corresponding compact LP relaxation and permits efficient optimization of the corresponding ILP. CG can be utilized to solve expanded LP relaxations. Since the set of all feasible columns is large and cannot be easily enumerated, a sufficient set of columns is constructed iteratively utilizing CG. Pricing refers to the process of identifying negative reduced cost columns. Pricing is performed by solving a small scale combinatorial optimization problem parameterized by the dual solution of the expanded LP relaxation defined over the nascent set of columns.

CG can be accelerated utilizing application specific DOI which decrease a size of the space of dual solutions that CG searches over. DOI are constraints on the space of dual solutions that do not change the objective of the optimal primal/dual solution generated at the conclusion of CG. General classes of DOI can accelerate CG optimization for applications in computer vision, entity resolution, and operations research. A known approach adapts a flexible DOI (F-DOI) framework to describe rebates for over-including customers. This approach observes that similar customers (e.g., with regards to spatial position and demand) should be associated with similar dual values resulting in smooth DOI (S-DOI). In this approach, the combination of S-DOI and F-DOI is referred to as SF-DOI and is tested on a single source capacitated facility location. SF-DOI can provide up to 130 times speed up for the problems considered by the aforementioned approach while provably not changing the final solution.

Some classes of mixed-integer optimization problems, such as the CVRP, consider a super-set of the columns including original columns (e.g., valid columns) and additional columns (e.g., relaxed columns) to increase tractability of pricing. SF-DOI does not provide for modeling relaxed columns. In the CVRP, a column is valid if it (1) does not include a customer more than once (e.g., no cycles in the corresponding route), and (2) does not service more demand than the vehicle has capacity. The pricing problem for CVRP is an elementary resource constrained shortest path problem, which is strongly NP-hard. A super-set of the set of valid columns, referred to as ng-routes, can facilitate solving large CVRP instances. Ng-routes provide for making pricing tractable at the cost of a decrease in the tightness of the underlying expanded LP relaxation. The ng-route relaxation provides for a customer to be visited more than once in a route but precludes many short cycles localized in space.

A review of the minimum weight set cover formulation utilized in operations research along with the CG solution and its application to vehicle routing will now be described. A minimum weight set cover problem can be solved via a standard CG method. [symbol] denotes a set of N∈Z₊ items to be covered and the CG formulation includes a continuous variable θₗ≥0 for every column l∈Ω where Ω is the set of all valid columns. In the standard cover formulation, a column can cover an item at most once. This can be relaxed when considering relaxed columns such as ng-routes, which can cover an item more than once. In the context of CG, the set Ω is generally exponentially large with respect to N, and therefore it can be impractical to explicitly consider the entire set Ω during optimization. Accordingly, for every column l∈Ω and for every item u∈ [symbol] , αᵤₗ∈{0,1} can be a binary constant equal to 1 if l covers u and otherwise αᵤₗ=0. A cost cₗ can be associated with the column l via a non-decreasing function over αᵤₗ ∀u∈ [symbol] . The minimum weight set cover is given by Equation 1 below:

$$\begin{matrix}{min}_{θ \geq 0} & {\sum }_{l ∈ Ω} {c}_{l} {θ}_{l} \\ {\sum }_{l ∈ Ω} {a}_{ul} {θ}_{l} \geq 1 & ∀ u ∈ 𝒩\end{matrix} \qquad Equation 1$$

Given the unscalability of enumerating the set Ω explicitly, CG considers a subset Ω_{R}⊂Ω at any given time, and thus the optimization (referred to as the restricted master problem or RMP) obtains the solution of the problem (e.g., RMP(Ω_{R})) in Equation 1 but restricted to the columns in Ω_{R}. Additionally, (αᵤ [symbol] can denote the dual variables associated with the constraints Σ_{i∈Ω}αᵤₗθᵢ≥1 in problem RMP(Ω_{R}). The reduced cost of a column l∈Ω\Ω_{R} can be computed as c̅ₗ̅=cₗ− [symbol] αᵤαᵤₗ. Therefore, problem RMP(Ω_{R}) provides a proven optimal solution of Equation 1 if min{c̅ₗ̅:l∈Ω\Ω_{R}}≥0. It should be understood that determining negative reduced cost columns is application specific but is generally a small scale combinatorial optimization problem.

Utilizing DOI to accelerate CG will now be described. DOI provide bounds on the dual variables, which provably do not remove all dual optimal solutions. DOI are utilized to decrease the search space over α, and hence accelerate optimization. Generally, DOI are applied to specific problems with specially tailored structure (e.g., the cutting stock problem). Recently, known approaches have demonstrated that DOI, such as S-DOI, F-DOI and SF-DOI, can be constructed for general classes of problems. These DOI are described in further detail below with respect to minimum weight set cover formulations.

S-DOI formalize the intuition that similar items are nearly fungible, and hence that their dual variables should have similar values. In mathematically describing S-DOI, Ωᵤ denotes a set of columns in Ω including item u and for any given l∈Ω, u∈ [symbol] , v∈ [symbol] s.t. l∈Ωᵤ−Ωᵥ, \hat{l}=swap(l,u,v) denotes a column corresponding to replacing u with v in l. Additionally, ρᵤᵥ denotes be an upper bound on an amount that any column including u but not v increases in cost when u is replaced by v. Formally, ρᵤᵥ satisfies Equation 2 as follows:

ρᵤᵥ≥c_{\hat{l}}−cₗ ∀l∈Ωᵤ−Ωᵥ, \hat{l}=swap(l,u,v) Equation 2

Given ρᵤᵥ as defined in Equation 2, it is known that the dual values a can be bounded as follows in Equation 3 below without weakening the relaxation in Equation 1:

ρᵤᵥ≥αᵥ−αᵤ ∀e∈ [symbol] , v∈ [symbol] , u≠v Equation 3

It should be understood that if the swap operation makes a column invalid, then a cost of the resultant column is regarded as infinite. S can denote a set of pairs u, v where ρᵤᵥ<∞ such that Sᵤ⁻ can denote a subset of S including (u, v) for all v∈ [symbol] and Sᵤ⁺ can denote a subset of S including (u, v) for all v∈ [symbol] .

In the primal LP including S-DOI as described in further detail below, S-DOI provides for items to be uncovered in exchange for a penalty being paid and other items being over-covered. The primal LP introduces variables of the form ωₛ (∀s∈S) for s=(u, v) which can be understood as counting a number of times u is swapped for v at cost ρᵤᵥ.

F-DOI can exploit the observation that if any item u is included more than once in a solution to the RMP, then that primal solution can be altered to remove excess of item u from columns while decreasing the objective and preserving feasibility. In particular, σᵤₗ denotes a rebate for over-covering an item u using a column l and for a column l∈Ω, u∈ [symbol] , σᵤₗ can be defined to satisfy the following properties: (1) σᵤₗ≥0, (2) αᵤₗ=0⇒σᵤₗ=0, and (3) the satisfaction of Equation 4 below. Equation 4 utilizes remove (l, [symbol] ) to denote a column constructed by removing [symbol] from l where [symbol] is a subset of [symbol] which is the set of items composing l. Equation 4 is as follows:

$${\sum }_{u ∈ \hat{𝒩}} {σ}_{ul} \leq {c}_{l} - {c}_{{l}^{′}} ∀ l ∈ Ω , \hat{𝒩} ⊆ {𝒩}_{l} = \{ u ∈ 𝒩 \text{:} {a}_{ul} = 1 \} , \\ {l}^{′} = remove ( l , \hat{𝒩} ) \qquad Equation 4$$

Equation 5 provides a sufficient condition to satisfy the requirement in Equation 4 and is as follows:

$${σ}_{ul} \leq {min}_{{{𝒩}_{l} ⊆ {𝒩}_{1}}_{{\hat{l} ∈ {Ω}_{u}}_{\overline{l} = remove ( i , \{ u \} )}}} {c}_{l} - {c}_{\overline{l}} {∀}_{u} ∈ 𝒩 , l ∈ {Ω}_{u} , \qquad Equation 5$$

Utilizing σ, the primal RMP can be augmented with additional variables which provide for the removal of items from columns in exchange for rebates provided according to σ. As mentioned above, σᵤₗ denotes the rebate for over-covering item u utilizing column l. The primal LP introduces variables of the form ξ_{uσ}, which counts a number of times u is removed from a column l for rebate σ. The primal LP is described in further detail below.

To prove that Equation 5 is a sufficient condition to satisfy Equation 4, \hat{l}ᵤ, \hat{l}₋ᵤ, σᵤₗ can be defined as the arg minimizer and minimizer of the right hand side (RHS) of Equation 5 respectively according to Equation 6 below:

$$\begin{matrix}{\hat{l}}_{u} = arg {min}_{{i ∈ {Ω}_{u}}_{{𝒩}_{i} ⊆ {𝒩}_{ι}}} {c}_{\hat{l}} - {c}_{{\hat{l}}_{- u}} & Equation 6 \\ where {l}_{- u} = remove ( \hat{l} , u ) \\ {σ}_{ul} = {c}_{{\hat{l}}_{u}} - {c}_{{\hat{l}}_{- u}} & \end{matrix}$$

Items in [symbol] can be removed from l in an arbitrary order where uₖ denotes the k'th member in [symbol] and lₖ refers to a column constructed by removing the first k items in [symbol] from l. Observing that l₀=l and [symbol] =l′, Equation 4 can be rewritten utilizing Equation 6 to define σᵤₗ and to add 0=Σₖ₌₁^{|N|}cₗ_{ₖ}−cₗ_{ₖ} to the RHS to yield Equation 7 below:

$${\sum }_{u ∈ \hat{𝒩}} {σ}_{ul} = {\sum }_{u ∈ \hat{𝒩}} {c}_{{\hat{l}}_{u}} - {c}_{{\hat{l}}_{- u}} \leq {c}_{l} - {c}_{{l}^{′}} = {\sum }_{k = 0}^{\vert {𝒩}_{l} \vert - 1} {c}_{{l}_{k}} - {c}_{{l}_{k + 1}} \qquad Equation 7$$

It can be observed that cₗ_{ᵤ}−c_{\hat{l}-u}≤cₖ_{_{k−1}}−cₗ_{ₖ} by definition in Equation 6 for all 1≤k≤ [symbol] . Therefore, Equation 7 is valid by construction and, as such, Equation 4 is satisfied by Equation 5.

SF-DOI in optimization will now be described. As mentioned above, the variable ξ_{uσ} represents a number of columns l from which u can be removed with a rebate of σ. The variable is a non-negative variable for every u∈ [symbol] and for every σ∈Λᵤ where Λᵤ={σᵤₗ: l∈Ω_{R}} is a set of all possible values of σᵤₗ across Ω_{R}. Equation 8 below formulates a minimum weight set cover augmented with SF-DOI as optimization where β_{ulσ} is a binary constant equal to 1 if σᵤₗ=σ and otherwise β_{ulσ}=0, and where one non-negative variable ωₛ is added for every s∈S such that ωₛ denotes a number of times swap s is applied.

$$Equation 8$$

$${min}_{{θ \geq 0}_{{ω \geq 0}_{ξ \geq 0}}} {\sum }_{l ∈ Ω} {c}_{l} {θ}_{l} + {\sum }_{s ∈ S} {ρ}_{s} {ω}_{s} - {\sum }_{{u ∈ 𝒩}_{σ ∈ {Λ}_{u}}} σ {ξ}_{u σ}$$

$$s . t . {ξ}_{u σ} - {\sum }_{l ∈ Ω} {β}_{ul σ} {θ}_{l} \leq 0 ∀ u ∈ 𝒩 , σ ∈ {Λ}_{u}$$

$${\sum }_{l ∈ Ω} {a}_{ul} {θ}_{l} + {\sum }_{s ∈ {S}_{u}^{+}} {ω}_{s} - {\sum }_{s ∈ {S}_{u}^{-}} {ω}_{s} - {\sum }_{σ ∈ {Λ}_{u}} {ξ}_{u σ} \geq 1 {∀}_{u} ∈ 𝒩$$

It should be understood that the SF-DOI do not weaken the LP relaxation such that Equation 1=Equation 8.

Decreasing a number of primal variables and primal constraints in the form of Equation 8 can accelerate optimization without loosening the LP relaxation. With respect to accelerating F-DOI, optimization over Ω can contain a large number of ξ variables as indexed by all the possible values of σ. To circumvent induced difficulties, a known approach rounds down the σᵤₗ values such that there is a small finite set for each u and therefore no explosion in the number of variables or constraints. With respect to accelerating S-DOI, a number of S-DOI grows quadratically (in a worst case) in [symbol] . To circumvent the enumeration of a quadratic number of variables, a portion of the S-DOI can be utilized. For example, a known approach utilizes the most restricting S-DOI (e.g., those s∈ [symbol] with the smallest ρₛ values).

As mentioned earlier, pricing can be computationally challenging or NP-hard. To facilitate solving difficult pricing problems, a known approach performs CG optimization over a super-set of Ω, denoted as Ω⁺, for which pricing can be solved efficiently over. Accordingly, Ω can be replaced with Ω⁺ in Equations 1 and 8. The additional columns (Ω⁺ \Ω) can be referred to as relaxed. It should be understood that considering Ω⁺ instead of Ω can loosen the relaxation. However, if the members of (Ω⁺ \Ω) are inactive at the conclusion of CG, then the solution is equal to that corresponding to optimization over Ω.

It is possible that the mechanism that generates DOI can be imperfect thereby yielding DOI that cut off all dual optimal solutions. However, the DOI can be intuitive and close to correct. Accordingly the DOI (e.g., relaxed DOI), while invalid, can accelerate optimization of a slightly weaker LP relaxation. Relaxed DOI can be removed, as needed, to ensure that the LP relaxation is not weakened. For example, in application of SF-DOI, any ω or ξ variables that have non-zero values at the conclusion of CG can be removed from the primal LP. Then, optimization is restarted, utilizing the current set of Ω_{R} for the initialization of CG. This can be repeated until no DOI are active at the conclusion of CG. This must terminate since there are a finite number of ω and ξ terms. It should be understood that the use of relaxed DOI could make the RMP unbounded in the primal and infeasible in the dual. To correct this, primal variables corresponding to DOI should be removed when the RMP would set them to ∞. As described in further detail below, during testing of the system of the present disclosure, unbounded primal RMP objectives/solutions are not observed.

The formulation of CVRP as a minimum weight set cover problem based on several terms and variables will now be described with reference to Equation 9 below. The range {1, 2 . . . N} denotes a set of customers and 0, N+1 respectively denotes the starting and ending depots where N is a number of customers. Additionally, Ω denotes a set of feasible routes which are indexed by l, each of which starts at the starting depot and ends at the ending depot. A route is feasible if it contains no customer more than once and services no more demand that it has capacity. Ω can be described utilizing αᵤₗ∈{0,1} where αᵤₗ=1 if and only if route l services customer u and αᵤₗ=0 otherwise. If a route visits a given customer u, then that route services the entire demand of that customer u. The positive integer dᵤ denotes a number of units of commodity that are demanded by customer u and the positive integer K denotes a capacity of a single vehicle. The capacity constraint for a vehicle route can be given by Equation 9 as follows:

$${\sum }_{u ∈ 𝒩} {a}_{ul} {d}_{u} \leq K ∀ l ∈ Ω \qquad Equation 9$$

As described in further detail below in reference to Equation 10, cₗ denotes the cost of any route l ∈Ω. Additionally, Tᵤᵥₗ=1 indicates that in a route l, a customer (or depot) u is followed immediately by customer (or depot) v and cᵤᵥ denotes the associated cost which is the distance between u, v in metric space. In CVRP, cᵤᵥ satisfies the triangle inequality. The cost cₗ is a fixed constant f∈ [symbol] ₀₊ for instantiating the vehicle plus the total distance traveled on route l. The offset f corresponds to a dualized constraint providing an upper bound on a number of vehicles utilized. The range [symbol] ={1, 2, 3 . . . N} denotes the set of customers and [symbol] ⁺ denotes the union of the set [symbol] , the starting depot 0 and ending depot N+1. Accordingly, cₗ is defined by Equation 10 as follows:

$${c}_{l} = f + {\sum }_{{u ∈ {𝒩}^{+}}_{v ∈ {𝒩}^{+}}} {T}_{uvl} {c}_{uv} \qquad Equation 10$$

It should be understood that CVRP can be commonly attacked as a minimum weight set cover problem utilizing the formulation in Equation 1 and determining negative reduced cost columns can be attacked as an elementary resource constrained shortest path problem (ERCSPP) which is strongly NP-Hard. Specifically, the computational difficulty of the ERCSPP grows exponentially in [symbol] .

The difficulty of solving the ERCSPP is a consequence of enforcing the elementarity constraint during pricing which states that no item can be included more than once in a route. To circumvent the difficulty of enforcing elementarity, a known approach is to weaken the LP relaxation in Equation 1 to consider a superset of vehicle routes Ω, denoted as Ω⁺ and referred to as the set of ng-routes. The ng-route relaxation partially relaxes elementarity by enforced elementarity only between nearby customers as described in further detail below.

Each customer is associated with a subset [symbol] ⊂ [symbol] referred to as its neighborhood, corresponding to its nearest neighbors in metric space. A size of the neighborhood is a user defined hyper-parameter which trades off tightness of the relaxation and optimization difficulty. A route lies in the expanded set Ω⁺ if no cycle within a route starting and ending at u includes exclusively customers for which u is one of their neighbors. Formally, let m₁, m₂ be positive integers where 1≤m₁<m₂≤ [symbol] αᵤₗ and let uₘ be the m'th customer visited in the route l. A route l in Ω⁺ if capacity is not violated (as described by Equation 9) and ∀m₁, m₂ s.t. uₘ_{₁}=uₘ_{₂} there exists m₁<m<m₂ s.t. uₘ_{₁}∉ [symbol] ᵤ_{ₘ}. It should be understood that the presence of cycles within routes is indicative that αᵤₗ lies in [symbol] ₀₊ and not {0, 1}.

No optimal binary valued solution to Equation 8 utilizes a route in Ω⁺−Ω since a cost of the solution could be decreased by removing customers from active routes such that no customer is included more than once. However, an optimal fractional solution to Equation 8 can include routes in Ω⁺−Ω. In practice, optimization over Ω⁺ does not significantly weaken the relaxation. It is known that determining a lowest reduced cost ng-route can be efficiently computed via a dynamic program.

The systems and methods of the present disclosure address the problem of accelerating CG for set cover problems in which a state space of the columns is relaxed to perform efficient pricing by adapting S-DOI and F-DOI for use with relaxed columns. As described above, S-DOI exploit the observation that similar items are nearly fungible and therefore should be associated with similarly valued dual variables, and F-DOI exploit the observation that a change in cost of a column induced by removing an item can be bounded. As such, the systems and methods of the present disclosure adapt S-DOI and F-DOI to the CVRP with respect to ng-routes relaxed columns to yield a SF-DOI framework and demonstrate that the SF-DOI accelerate CG optimization over the ng-routes relaxed columns without provably weakening the relaxation.

Turning to the drawings, FIG. 1 is a diagram illustrating an embodiment of the system 10 of the present disclosure. The system 10 could be embodied as a central processing unit 12 (processor) in communication with a database 14. The processor 12 could include, but is not limited to, a computer system, a server, a personal computer, a cloud computing device, a smart phone, or any other suitable device programmed to carry out the processes disclosed herein. The system 10 could determine SF-DOI for CVRP and implement the SF-DOI to accelerate CG optimization over ng-routes relaxed columns of a CVRP dataset obtained from the database 14.

The database 14 could include benchmark CVRP datasets including, but not limited to, the A, B, P and E datasets. The processor 12 executes automated vehicle routing system code 16 which accelerates CG optimization over ng-routes relaxed columns on a dataset obtained from the database 14, in order to automatically route one or more vehicles. The system 10 includes system code 16 (non-transitory, computer-readable instructions) stored on a computer-readable medium and executable by the hardware processor 12 or one or more computer systems. The code 16 could include various custom-written software modules that carry out the steps/processes discussed herein, and could include, but is not limited to, a S-DOI generator 18a, a F-DOI generator 18b, and a SF-DOI optimizer 18c. The code 16 could be programmed using any suitable programming languages including, but not limited to, C, C++, C#, Java, Python or any other suitable language. Additionally, the code 16 could be distributed across multiple computer systems in communication with each other over a communications network, and/or stored and executed on a cloud computing platform and remotely accessed by a computer system in communication with the cloud platform. The code 16 could communicate with the database 14, which could be stored on the same computer system as the code 16, or on one or more other computer systems in communication with the code 16. The routing instructions generated by the automated vehicle routing system code 16 could be transmitted to one or more vehicle controllers (e.g., vehicle navigation system controller, etc.), such that the vehicle controllers can operate the vehicle in accordance with the route determined by the system code 16. The types of vehicles that can be controlled by the code 16 include, but are not limited to, cars, trucks, airplanes, unmanned aerial vehicles (UAVs), or any other type of vehicle that is capable of being controlled by a vehicle controller.

Still further, the system 10 could be embodied as a customized hardware component such as a field-programmable gate array (“FPGA”), application-specific integrated circuit (“ASIC”), embedded system, or other customized hardware components without departing from the spirit or scope of the present disclosure. It should be understood that FIG. 1 is only one potential configuration, and the system 10 of the present disclosure can be implemented using a number of different configurations.

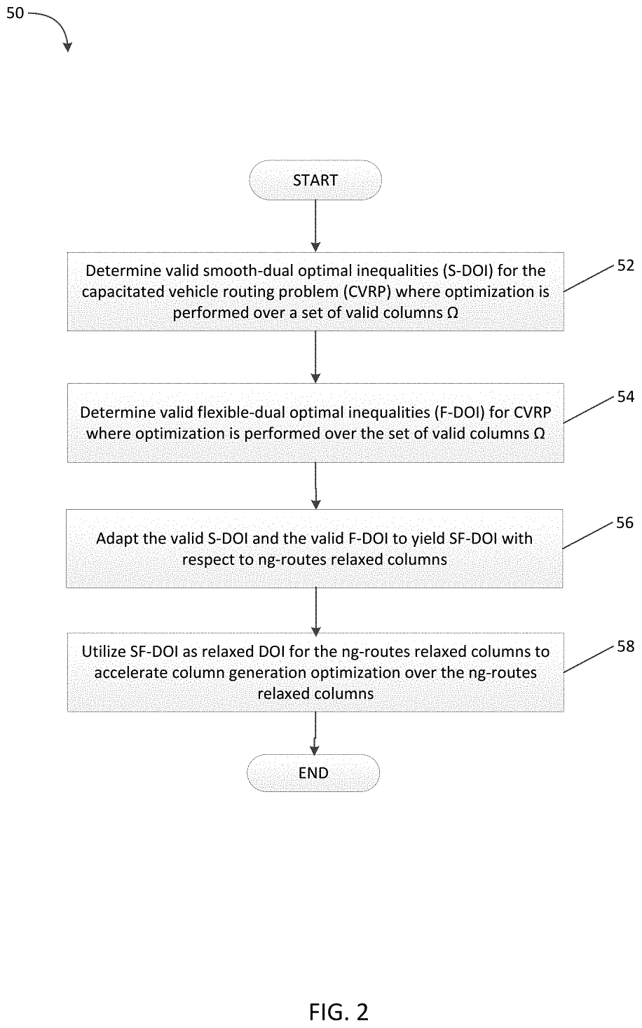

FIG. 2 is a flowchart illustrating overall processing steps 50 carried out by the system 10 of the present disclosure. Beginning in step 52, the system 10 determines valid S-DOI for the CVRP where optimization is performed over a set of valid columns Ω. In step 54, the system 10 determines valid F-DOI for the CVRP where optimization is performed over the set of valid columns Q. Then, in step 56, the system 10 adapts the S-DOI and the F-DOI to yield SF-DOI with respect to ng-routes relaxed columns. In step 58, the system 10 utilizes the SF-DOI as relaxed DOI for the ng-routes relaxed columns to accelerate CG optimization over the ng-routes relaxed columns, in order to generate an optimal route for a vehicle. The optimal route can then be utilized to automatically control operation of a vehicle, if desired.

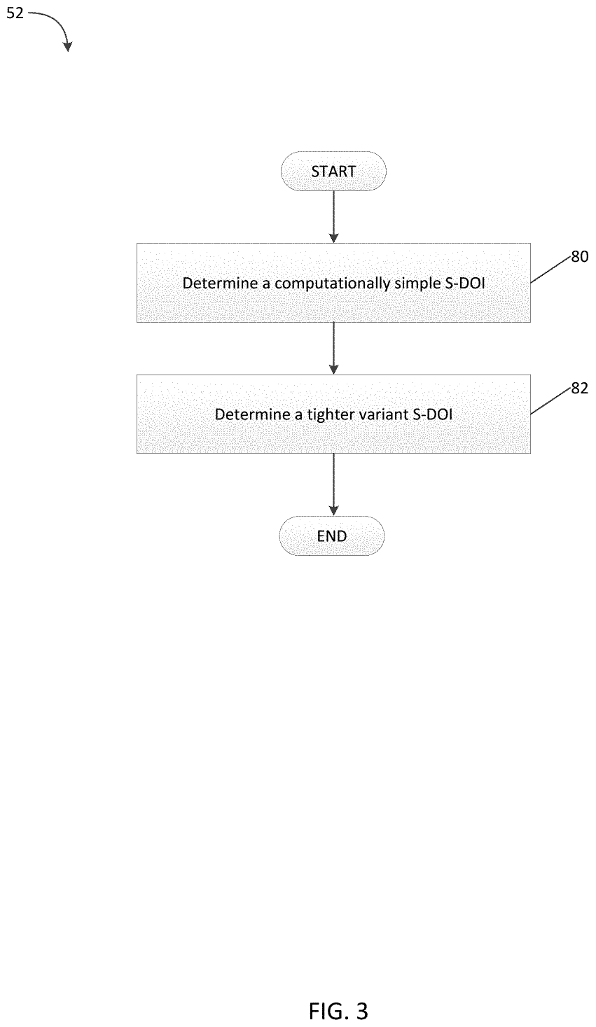

FIG. 3 is a flowchart illustrating step 52 of FIG. 2 in greater detail. Beginning in step 80, the system 10 determines a computationally simple S-DOI. As mentioned earlier, Equation 9 demonstrates that (u, v)∈S if and only if the demand of a customer u is greater than or equal to the demand of a customer v (e.g., dᵤ≥dᵥ). Considering any s and route l∈Ωᵤ−Ωᵥ, l′ can be a route generated by replacing u with v in l (e.g., l′=swap (l, u, v)) and u₋, u₊ can be the customers or depots immediately preceding/succeeding u in l. Accordingly c_{l′}−cₗ is given by Equation 11 below as:

c_{l′}−cₗ=(cᵤ_{_{−}}ᵥ−cᵤ_{_{−}}ᵤ)+(cᵥᵤ_{₊}−cᵤᵤ_{₊}) Equation 11

It should be understood that via the triangle inequality cᵤ_{_{−}}ᵥ≤cᵤ_{_{−}}ᵤ+cᵤᵥ and cᵥᵤ_{₊}≤cᵤᵥ+cᵤᵤ_{₊}. As shown below in Equation 12, the system 10 can plug in these upper bounds on cᵤ_{_{−}}ᵥ and into Equation 11 as follows:

c_{l′}−cₗ≤2cᵤᵥ Equation 12

Therefore, setting ρᵤᵥ=2cᵤᵥ for all pairs of unique elements u, v s.t. dᵤ≥dᵥ satisfies Equation 2.

In step 82, the system 10 determines a tighter variant of S-DOI. It should be understood that ρᵤᵥ for u, v in the context of vehicle routing is a maximum amount that the cost of a route can increase when replacing customer u with v. As mentioned earlier, (u, v)∈S if and only if the demand of a customer u is greater than or equal to the demand of a customer v (e.g., dᵤ≥dᵥ). Accordingly, ρᵤᵥ is given by Equation 13 below:

$${ρ}_{uv} = {max}_{{{u}_{1} ∈ {𝒩}^{+} - ( N + 1 ) - u - v}_{{u}_{2} ∈ {𝒩}^{+} - 0 - u - v - {u}_{1}}} ( {c}_{{u}_{1} v} + {c}_{{vu}_{2}} ) - ( {c}_{{u}_{1} u} + {c}_{{uu}_{2}} ) \qquad Equation 13$$

It should be understood that by iterating over all possible pairs ∈+{0 . . . N+1}, the system 10 can efficiently evaluate ρᵤᵥ.

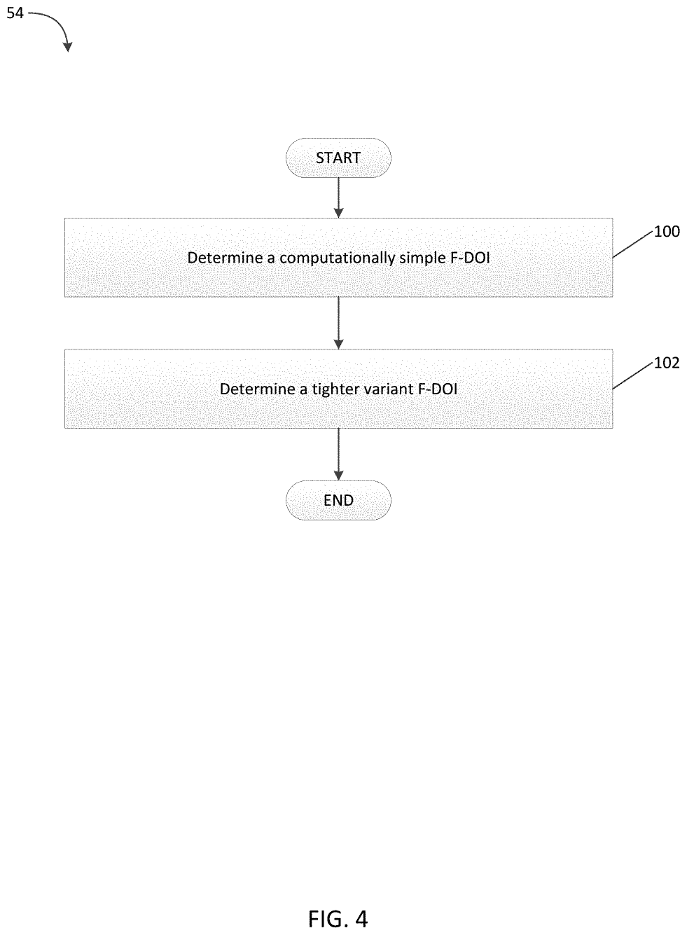

FIG. 4 is a flowchart illustrating step 54 of FIG. 2 in greater detail. Beginning in step 100, the system 10 determines a computationally simple F-DOI. In particular, the system 10 considers the constraints required to satisfy the description of F-DOI as described earlier with respect to Equation 5. The system 10 sets σᵤₗ=0 when αᵤₗ=0 and otherwise utilizes the maximum value satisfying Equation 5. The system 10 determines the maximum value satisfying Equation 5 by considering all possible predecessor/successor pairs for u constructed from route l and respecting the order of route l. Then, the system 10 connects the predecessor to the successor directly instead of via u in the route created by removing u. Equation 14 below describes σᵤₗ as optimization by denoting the customers/depots that include a route l in the order that they are visited in route l from first to last with: l={u₀^{l}, u₁^{l}, u₂^{l} . . . [symbol] , u_{N+1}^{l}} where u₀^{l}, u_{N+1}^{l} respectively denote the starting depot and the ending depot

$${σ}_{ul} ← {min}_{{( i , j ) : i < k < j}_{u = {u}_{k}^{l}}} \{ {c}_{{u}_{i}^{l} u} + {c}_{{uu}_{j}^{l}} - {c}_{{u}_{i}^{l} {u}_{j}^{l}} \} l ∈ Ω , \qquad Equation 14$$

In step 102, the system 10 determines a tighter variant F-DOI. In particular, the system 10 considers the constraints required to satisfy the description of F-DOI as described earlier with respect to Equation 5 utilizing the notation mentioned above with respect to Equation 14. The system 10 utilizes vᵢⱼ^{l} to denote a change in cost incurred by removing all of uᵢ^{l}, uᵢ₊₁^{l}, uᵢ₊₂^{l} . . . uᵢ₊ⱼ^{l} from l and connecting uᵢ₋₁^{l} to uᵢ₊ⱼ₊₁^{l} directly. Equation 15 formally describes vᵢⱼ^{l} below:

$${v}_{i , j}^{l} = {c}_{{u}_{i - 1}^{l} {u}_{i + j + 1}^{l}} - {\sum }_{n = i}^{i + j + 1} {c}_{{u}_{n - 1}^{l} {u}_{n}^{l}} \qquad Equation 15$$

It should be understood that v is non-positive because the triangle inequality holds for the CVRP. The system 10 can utilize express c_{\hat{l}} for \hat{l}=remove(l, [symbol] ) for and \hat{N}⊆ [symbol] using Aᵢⱼ^{l}∈{0,1}, which is defined for all 1≤i, 0≤j, i+j≤| [symbol] |. Here, Aᵢⱼ^{l}=1 indicates that none of the customers {uᵢ^{l}, uᵢ₊₁^{l}, uᵢ₊₂^{l} . . . uᵢ₊ⱼ^{l}} are included in I but both the customer/depot preceding uᵢ^{l} and succeeding uᵢ₊ⱼ^{l} are included and otherwise Aᵢⱼ^{l}=0. Utilizing v, A, Equation 16 defines c_{\hat{l}} below:

$${c}_{\hat{l}} = {c}_{l} + {\sum }_{{i \geq 1}_{{j \geq 0}_{i + j \leq \vert {𝒩}_{l} \vert}}} {v}_{ij}^{l} {A}_{ij}^{\hat{l}} \qquad Equation 16$$

Applying Equation 16 to Equation 4 and re-ordering the terms thereof yields Equations 17 and 18 below:

$$\begin{matrix}{c}_{l} - {c}_{\hat{l}} \geq {\sum }_{u ∈ \hat{𝒩}} {σ}_{ul} & Equation 17 \\ {c}_{l} \geq {c}_{l} + {\sum }_{{i \geq 1}_{{j \geq 0}_{i + j \leq \vert {𝒩}_{l} \vert}}} {A}_{ij}^{\hat{l}} ( {v}_{ij}^{l} + {\sum }_{n = i}^{i + j} {σ}_{{u}_{n}^{l} l} ) & Equation 18\end{matrix}$$

It is a necessary and sufficient condition to ensure that Equation 18 is obeyed such that for every i≥1, j≥0, i+j≤| [symbol] ₗ| Equation 19 holds as follows:

$$0 \geq {v}_{ij}^{l} + {\sum }_{n = i}^{i + j} {σ}_{{u}_{n}^{l} l} \qquad Equation 19$$

Utilizing Equation 19, the system 10 considers the selection of σᵤₗ as optimization. Additionally, the system 10 seeks to maximize [symbol] σᵤₗ such that Equation 19 is satisfied. In particular, the system 10 maximizes [symbol] σᵤₗ to maximize the “rebate” received when solving the RMP thus decreasing the object of the current RMP. This can be defined as an LP as shown by Equation 20 below:

$$0 \geq {v}_{ij}^{l} + {\sum }_{n = i}^{i + j} {σ}_{{u}_{n}^{l} l} ∀ \{ i \geq 1 , j \geq 0 , i + j \leq \vert {𝒩}_{l} \vert \} \qquad Equation 20$$

Solving Equation 20 is a small LP with | [symbol] | variables and

$$\vert {𝒩}_{l} \vert + ( \begin{matrix}\vert {N}_{l} \vert \\ 2\end{matrix} )$$

constraints. An objective is that a [symbol] ₂ norm be imposed on σᵤₗ to generate a solution that does not have extreme valued σ variables and hence encourage extreme valued α terms. Accordingly, the system 10 minimizes the [symbol] ₂ norm of the σ terms subject to the constraints that are near optimal (e.g., within a factor δ=0.999 of optimality) with respect to Equation 20. This optimization is shown by Equation 21 below:

$${min}_{σ \geq 0} {\sum }_{u ∈ {𝒩}_{l}} {σ}_{ul} {σ}_{ul} \\ 0 \geq {v}_{ij}^{l} + {\sum }_{n = i}^{i + j} {σ}_{ul} ∀ \{ i \geq 1 , j \geq 0 , i + j \leq \vert {𝒩}_{l} \vert \} \\ {\sum }_{u ∈ {𝒩}_{i}} {σ}_{ul} \geq δ Eq 20 \qquad Equation 21$$

The determined S-DOI and F-DOI as described above in relation to FIGS. 3 and 4 are not valid for ng-routes. These DOI correspond to relaxed DOI as described in further detail below. With respect to S-DOI, the system 10 considers the ng-route l={0, u, v, u, N+1} where v∈ [symbol] and dᵤ≥dᵥ≥d_{\hat{v}}. It should be understood that replacing v with \hat{v} generates the route {0, u, \hat{v}, u, N+1} which is not an ng-route. Therefore, the S-DOI described above in relation to FIG. 3 are not valid for Ω⁺ even though they are valid for Ω. With respect to F-DOI, the system 10 again considers the ng-route l={0, u, v, u, N+1} where v∈ [symbol] . If v is removed from l, then the resulting route l={0, u, u, N+1} is not an ng-route. Therefore, the F-DOI described above in relation to FIG. 4 are not valid for Ω⁺ even though they are valid for Ω.

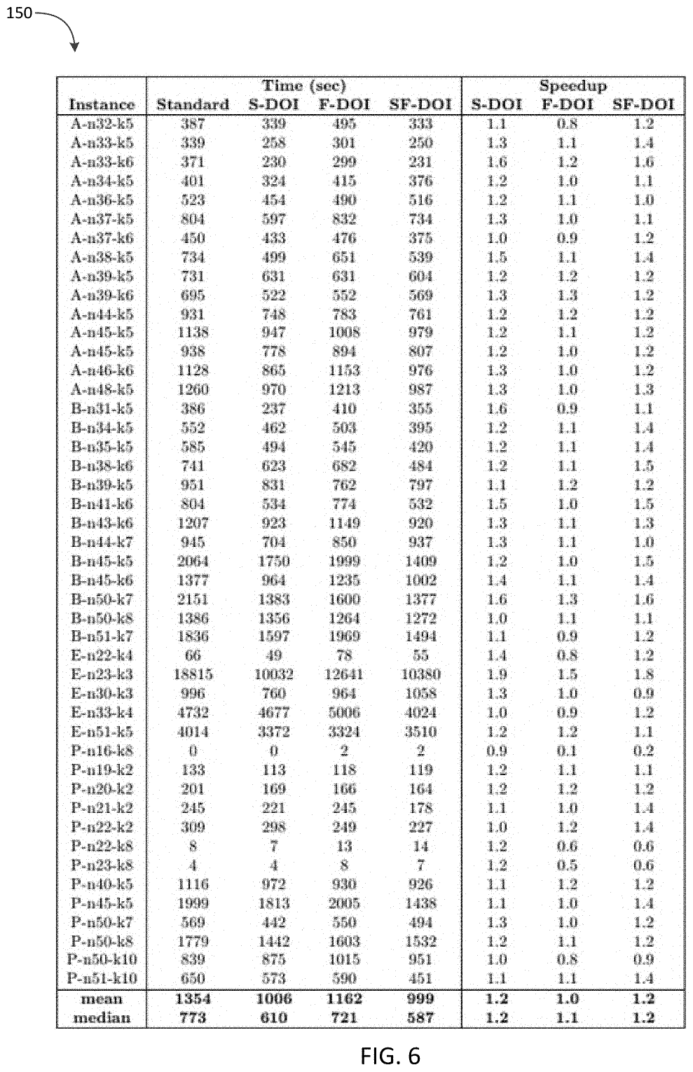

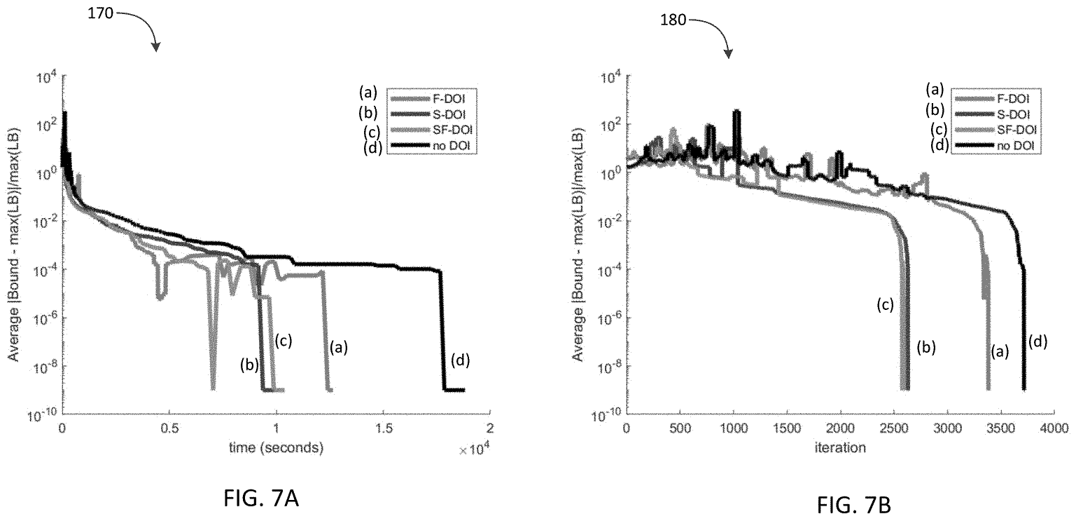

While the SF-DOI described above in relation to FIGS. 3 and 4 are valid for Ω and are not valid Ω⁺, it can be argued that these SF-DOI hold approximately for Ω⁺ since not all swap/removal operations generate columns that lie outside of Ω⁺. The effectiveness of the SF-DOI for CG optimization of ng-routes of the system 10 is described in detail below in relation to FIGS. 6 and 7A-B. As mentioned above, relaxed DOI are removed as required to ensure that the relaxed DOI do not prevent CG from optimally solving optimization over Ω⁺.

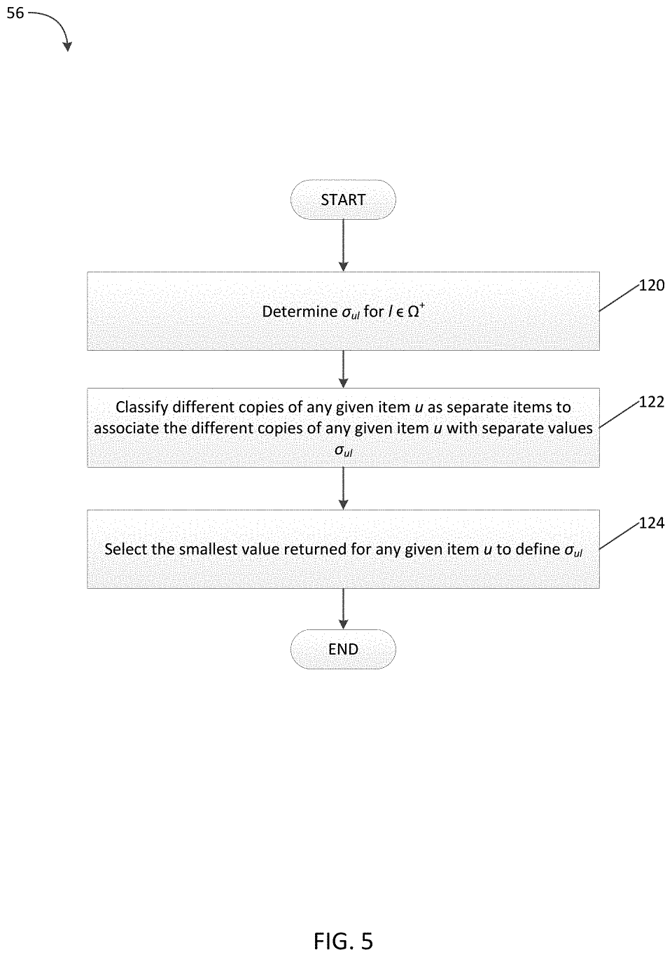

FIG. 5 is a flowchart illustrating step 56 of FIG. 2 in greater detail. In step 120, the system 10 determines σᵤₗ for l∈Ω⁺. The system 10 determines σᵤₗ terms utilizing Equations 20 and 21 as with any route in Ω. In step 122, the system 10 classifies different copies of any given item u as separate items which yields different copies of any given item u being associated with separate values of σᵤₗ. Then, in step 124, the system 10 selects the smallest value returned for any given item u to define σᵤₗ. The selection of the smallest value returned is referred to as the “smallest value rule” and ensures that the F-DOI do not trivially induce Equation 8 to be unbounded when optimization is performed over Ω⁺. For example, considering any l∈Ω⁺ and the primal feasible solution to Equation 8 defined by ξ_{uσ}=Mαᵤₗ ∀e∈ [symbol] , σ=σᵤₗ and θₗ=m where M=∞, then it should be understood that this solution has a primal objective equal to −∞ if Equation 22 below holds:

$${\sum }_{u ∈ 𝒩} {a}_{ul} {σ}_{ul} > {c}_{l} \qquad Equation 22$$

Accordingly, for any l∈Ω⁺, defining σᵤₗ utilizing the smallest value rule applied to any feasible solution to Equation 20 prevents Equation 22 from being satisfied.

Testing and processing results of the system 10 will now be described in relation to FIGS. 6 and 7. The system 10 tests the performance of the SF-DOI on four benchmark datasets including datasets A, B, P and E. Datasets A, B and P were introduced in 1995 and dataset E was introduced in 1969. The system 10 tests on instances with at most 50 customers and traversal costs are calculated as the Euclidean distance between customer locations rounded to the nearest integer. The system 10 solves the relaxed ng-routes problem where neighborhoods are set as the five nearest customers. Pricing amounts to solving an ng-route shortest path problem which is solved as a dynamic program. The system 10 evaluates DOI by the speedup in convergence they provide in comparison to non-stabilized CG. Algorithms are coded in MATLAB and CPLEX is utilized as the LP-solver. Tests are performed on an 8-core AMD Ryzen 1700 CPU at 3.0 GHz with 32 GB of memory executing Windows 10.

FIG. 6 is a table 150 illustrating computational results realized by the system 10 and FIGS. 7A-B are graphs 170 and 180 illustrating relative duality gaps displayed as a relative difference between upper and maximum lower bounds. In particular, the table 150 of FIG. 6 illustrates computational results on all 46 problem instances and graphs 170 and 180 of FIGS. 7A-B are aggregated plots respectively illustrating an average relative duality gap over the 46 problem instances as a function of time and an average relative duality gap over the 46 problem instances as a function of iteration. As shown in FIGS. 6 and 7A-7B, the S-DOI and SF-DOI provide an average speed up of twenty percent. The S-DOI provide a positive speed up in 44 out of 46 instances while the SF-DOI (utilizing both F-DOI and S-DOI) provide a positive speed up in 41 out of 46 instances. The F-DOI do not generate any average speed up over the instances. Additionally, a large portion of the speed up of the SF-DOI can be attributed to the S-DOI but the SF-DOI outperform the S-DOI in 21 out of 46 instances.

The process of removing active DOI at termination as described earlier is a necessary component for convergence. The S-DOI required the removal of active DOI in 2 out of 46 instances, while the F-DOI and SF-DOI both required the removal of active DOI in 42 out of 46 instances. The phenomena of DOI inducing unbounded RMP is not evident in the tests executed by the system 10.

The system 10 adapts SF-DOI to accelerate the convergence of CG when applied to minimum weight set covering based formulations with relaxed columns. Additionally, the system 10 applies the adapted SF-DOI to the CVRP formulated as a set cover problem over ng-routes. Tests executed by and computational results realized by the system 10 demonstrate significant improvement in the speed of optimization with no weakening of the underlying relaxation. Future applications of the system 10 can include operating in the context of branch and price and considering valid inequalities such as subset-row inequalities which are used to tighten the set cover LP relaxation. Another future application of the system 10 can include application of SF-DOI to VRPs with time windows.

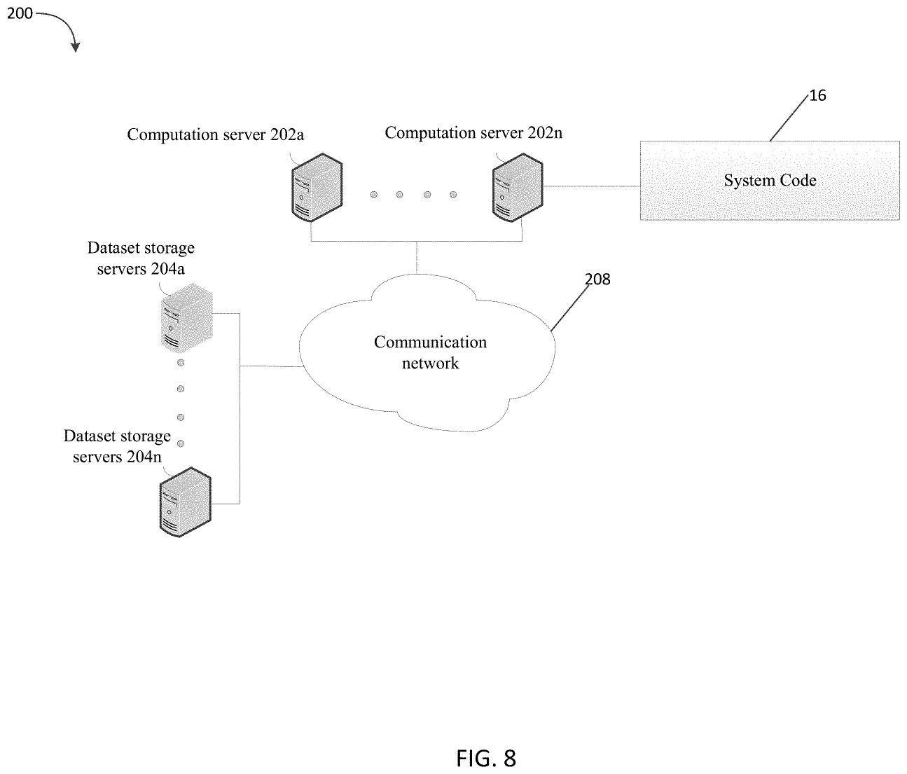

FIG. 8 a diagram illustrating another embodiment of the system 200 of the present disclosure. In particular, FIG. 8 illustrates additional computer hardware and network components on which the system 200 could be implemented. The system 200 can include a plurality of computation servers 202a-202n having at least one processor and memory for executing the computer instructions and methods described above (which could be embodied as system code 16). The system 200 can also include a plurality of dataset storage servers 204a-204n for storing CVRP datasets. The computation servers 202a-202n and the dataset storage servers 204a-204n can communicate over a communication network 208. Of course, the system 200 need not be implemented on multiple devices, and indeed, the system 200 could be implemented on a single computer system (e.g., a personal computer, server, mobile computer, smart phone, etc.) without departing from the spirit or scope of the present disclosure.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure.

1. A system for automated vehicle routing, comprising:
a memory; and
a processor in communication with the memory, the processor:
receiving capacitated vehicle routing problem (CVRP) input data;
generating a minimum weight set cover problem formulation for a CVRP for performing column generation optimization over the input data;
determining smooth-dual optimal inequalities (S-DOI) for the CVRP for performing the column generation optimization over a valid subset of the input data, the valid subset of the input data being a set of feasible vehicle routes;
determining flexible-dual optimal inequalities (F-DOI) for the CVRP for performing the column generation optimization over the set of feasible vehicle routes;
adapting the S-DOI and the F-DOI to generate smooth and flexible dual optimal inequalities (SF-DOI) for the CVRP for performing the column generation optimization over a relaxed subset of the input data, the relaxed subset of the input data being a super set of valid columns known called ng-routes; and
determining an optimal vehicle route utilizing the SF-DOI to accelerate column generation optimization over the set of ng-routes.

2. The system of claim 1, wherein the processor generates the minimum weight set cover problem formulation for the CVRP by determining a capacity constraint for a vehicle route and determining a cost of each vehicle route among the set of feasible vehicle routes.

3. The system of claim 1, wherein the valid subset of the input data is a set of valid columns and the relaxed subset of the input data is a set of relaxed columns.

4. The system of claim 1, wherein the processor adapts the S-DOI and the F-DOI to generate the SF-DOI for the CVRP for performing the column generation optimization over the set of ng-routes by:
determining a rebate value for over-covering an item of a vehicle route for each vehicle route among the set of ng-routes,
classifying different copies of each item as independent items to associate the different copies of each item with independent rebate values, and
selecting a smallest value returned among the classified items as the rebate value.

5. The system of claim 4, wherein selecting the smallest value returned among the classified items as the rebate value prevents the column generation optimization performed over the set of ng-routes from being unbounded by the F-DOI.

6. The system of claim 1, wherein the CVRP is a mixed integer linear program.

7. The system of claim 6, wherein the processor accelerates the column generation optimization over the set of ng-routes without weakening an underlying expanded linear program corresponding to the CVRP.

8. A system for automated vehicle routing comprising:
a memory; and
a processor in communication with the memory, the processor:
determining smooth and flexible dual optimal inequalities (SF-DOI) for a capacitated vehicle routing problem (CVRP) for performing column generation optimization over a valid subset of CVRP input data, the valid subset of the input data being a set of feasible vehicle routes;
adapting the SF-DOI for the CVRP for performing column generation optimization over a relaxed subset of the input data, the relaxed subset of the input data being a set of ng-routes; and
determining an optimal vehicle route utilizing the SF-DOI to accelerate column generation optimization over the set of ng-routes.

9. The system of claim 8, wherein the processor adapts the SF-DOI for the CVRP for performing the column generation optimization over the set of ng-routes by:
determining a rebate value for over-covering an item of a vehicle route for each vehicle route among the set of ng-routes,
classifying different copies of each item as independent items to associate the different copies of each item with independent rebate values, and
selecting a smallest value returned among the classified items as the rebate value.

10. The system of claim 9, wherein selecting the smallest value returned among the classified items as the rebate value prevents the column generation optimization performed over the set of ng-routes from being unbounded by the F-DOI of the SF-DOI.

11. The system of claim 8, wherein
the CVRP is a mixed integer linear program, and
the processor accelerates the column generation optimization over the set of ng-routes without weakening an underlying expanded linear program corresponding to the CVRP.

12. A method for automated vehicle routing, comprising:
receiving capacitated vehicle routing problem (CVRP) input data;
generating a minimum weight set cover problem formulation for a CVRP for performing column generation optimization over the input data;
determining smooth-dual optimal inequalities (S-DOI) for the CVRP for performing the column generation optimization over a valid subset of the input data, the valid subset of the input data being a set of feasible vehicle routes;
determining flexible-dual optimal inequalities (F-DOI) for the CVRP for performing the column generation optimization over the set of feasible vehicle routes;
adapting the S-DOI and the F-DOI to generate smooth and flexible dual optimal inequalities (SF-DOI) for the CVRP for performing the column generation optimization over a relaxed subset of the input data, the relaxed subset of the input data being a set of ng-routes; and
determining an optimal vehicle route utilizing the SF-DOI to accelerate column generation optimization over the set of ng-routes.

13. The method of claim 12, wherein the CVRP input data is one of an A, B, P, or E CVRP dataset.

14. The method of claim 12, wherein generating the minimum weight set cover problem formulation for the CVRP further comprises the steps of determining a capacity constraint for a vehicle route and determining a cost of each vehicle route among the set of feasible vehicle routes.

15. The method of claim 12 wherein the valid subset of the input data is a set of valid columns and the relaxed subset of the input data is a set of relaxed columns.

16. The method of claim 12, wherein the adapting the S-DOI and the F-DOI to generate the SF-DOI for the CVRP for performing the column generation optimization over the set of ng-routes further comprises the steps of:
determining a rebate value for over-covering an item of a vehicle route for each vehicle route among the set of ng-routes,
classifying different copies of each item as independent items to associate the different copies of each item with independent rebate values, and
selecting a smallest value returned among the classified items as the rebate value.

17. The method of claim 16, wherein selecting the smallest value returned among the classified items as the rebate value prevents the column generation optimization performed over the set of ng-routes from being unbounded by the F-DOI.

18. The method of claim 12, wherein the CVRP is a mixed integer linear program and utilizing the SF-DOI to accelerate the column generation optimization over the set of ng-routes does not weaken an underlying expanded linear program corresponding to the CVRP.

19. A non-transitory computer readable medium having instructions stored thereon for automated vehicle routing which, when executed by a processor, causes the processor to carry out the steps of:
determining smooth and flexible dual optimal inequalities (SF-DOI) for a capacitated vehicle routing problem (CVRP) for performing column generation optimization over a valid subset of CVRP input data, the valid subset of the input data being a set of feasible vehicle routes;
adapting the SF-DOI for the CVRP for performing column generation optimization over a relaxed subset of the input data, the relaxed subset of the input data being a set of ng-routes; and
determining an optimal vehicle route utilizing the SF-DOI to accelerate column generation optimization over the set of ng-routes,
wherein the CVRP is a mixed integer linear program and utilizing the SF-DOI to accelerate the column generation optimization over the set of ng-routes does not weaken an underlying expanded linear program corresponding to the CVRP.
